(19) United States
(12) Patent Application Publication
(10) Pub. No.: US 2010/0077418 A1
(43) Pub. Date: Mar. 25, 2010

(54) SLOT-IN DISK DRIVE WITH A RELEASE DEVICE

(76) Inventors: Yao-Ching Tsai, Taoyuan County (TW); Yao-Ting Kuo, Taoyuan County (TW); Jen-Chen Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/480,649

(22) Filed: Jun. 8, 2009

(30) Foreign Application Priority Data
Sep. 23, 2008 (TW) 097136586

(51) Int. Cl. G11B 17/04

(52) U.S. Cl. 720/617; G9B/17.013

(57) ABSTRACT

The invention includes a slot-in disk drive with a release device, wherein a side of a traverse is pivoted to a casing. A spindle motor disposed on the traverse rotates an optical disk with a non-data area. The release device is set on the traverse adjacent to the spindle motor. A first hole is formed on the traverse and located in a position corresponding to the non-data area. A release bar protrudes from a bottom of the casing for inserting into the first hole. A buffer is installed between the release bar and the traverse for isolating vibration.

### BACKGROUND OF THE INVENTION

1. Field of the Invention

The present invention relates to a slot-in disk drive, and more particularly, to a slot-in disk drive with a release device for releasing an optical disk from a spindle motor.

2. Description of the Prior Art

Due to larger capacity of an optical disk, the smaller size of data marks, and the highly concentrated density of data marks, an optical disk drive is composed of precision optical components, driving mechanisms, and electronic components, so that the optical disk drive is sensitive to vibration. Efficiency and accuracy of reading/writing the data of the optical disk drive is affected by tiny vibration easily, thus how to isolate the vibration is one of the most important issues of the optical disk drive.

As shown in FIG. 1, FIG. 1 is a diagram of a slot-in disk drive 1 in the prior art. The slot-in disk drive 1 includes a casing 2, a traverse 3 pivoted to the casing 2 by a pivoted bolt 4, a spindle motor 5 installed on the traverse 3, and a sliding pin 6 protruding from a side of the traverse 3 for inserting into a slot 8 of a sliding component 7. The sliding component 7 slides along a lateral side of the slot-in disk drive 1 so as to drive the sliding pin 6 along the slot 8 upward and downward. As a dotted line shown in FIG. 1, the traverse 3 is capable of rotating relative to the pivoted bolt 4 at small angels.

When an optical disk 9 is loaded by the slot-in disk drive 1 automatically, the traverse 3 and the spindle motor 5 are descended so as to load the optical disk 9 into the casing 2. Because the sliding pin 6 is ascended with the slot 8 and the traverse 3 is ascended with the sliding pin 6, the spindle motor 5 and a plate 10 are driven for clamping and rotating the optical disk 9 so as to read/write the data of the optical disk 9.

When the optical disk 9 is ejected by the slot-in disk drive 1, the sliding pin 6 is descended with the slot 8 and the traverse 3 and the spindle motor 5 are descended with the sliding pin 6. Because a central hole of the optical disk 9 is wedged on the spindle motor 5, the optical disk 9 is too flexible to be departed from the spindle motor 5 immediately. In order to prevent the descending optical disk 9 from being damaged, the slot-in disk drive 1 further includes a release device 11 installed on the traverse 3 adjacent to the spindle motor 5. A hole 12 is formed on the traverse 3 under a position corresponding to a non-data area 9a of the optical disk 9. A release bar 13 protrudes from a bottom of the casing 2 in a position corresponding to the hole 12 for inserting into the hole 12. When the optical disk 9 is clamped and rotated by the spindle motor 5, the release bar 13 stays inside the hole 12. When the spindle motor 5 is descended, the release bar 13 sticks out the hole 12 for holding the non-data area 9a of the optical disk 9, so that the optical disk 9 is not descended with the spindle motor 5 and departs from the spindle motor 5 for ejecting the optical disk 9.

However, a gap is formed between the release bar 13 and the hole 12 for passing the release bar 13 through the hole 12 easily. The hole 12 is formed on the traverse 3 and the release bar 13 protrudes from the casing 2, so that vibration caused by unbalanced high speed rotation of the slot-in disk drive or the vibration transmitted from the casing 2 of a portable or car-used disk drive might cause collision between the release bar 13 and the hole 12 easily. Therefore, the slot-in disk drive 1 in the prior art can not isolate the vibration and noise effectively so that the efficiency and the accuracy of reading/writing data are affected. The release device of the conventional slot-in disk drive still has drawbacks which have to be solved.

### SUMMARY OF THE INVENTION

The present invention provides a slot-in disk drive with a release device. The release device includes a buffer for isolating vibration transmitted between a traverse and a casing so as to decrease noise and increase efficiency of reading/writing data.

The present invention further provides the slot-in disk drive with the release device. The release device includes the buffer installed around a release bar, without moving with relative to the traverse, for preventing the buffer from falling.

According to the present invention, the slot-in disk drive with the release device includes the casing including a bottom, wherein a traverse is set inside the casing and pivoted to the casing, and a spindle motor is installed on the traverse for rotating an optical disk. The optical disk includes a non-data area. The release device includes a first hole formed on the traverse adjacent to the spindle motor and located in a position corresponding to the non-data area of the optical disk, the release bar protruding from a bottom of the casing in a position corresponding to the first hole for inserting into the first hole, and the buffer installed between the release bar and the traverse for isolating the vibration.

According to the present invention, the release bar stays inside the first hole and separates from the optical disk when the optical disk is loaded by the slot-in disk drive, and the release bar touches the non-data area of the optical disk when the optical disk is withdrawn by the slot-in disk drive. The buffer of the release device is a circular sheath. A circular slot is formed on an outer surface of the buffer, and a circular protrusion is formed on the first hole for fixing the buffer inside the first hole. A second hole is formed on the buffer wherethrough the release bar passes. The buffer can be further disposed around the release bar, and a fixing slot is formed on a surface of the release bar for engaging with the buffer. An inner surface of the first hole and the buffer are parallel so that the release bar with the buffer is capable of inserting into the first hole.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a slot-in disk drive in the prior art.

FIG. 2 is a diagram of a slot-in disk drive with a release device according to a first embodiment of the present invention.

FIG. 3 is a lateral view of a sliding component of the present invention.

FIG. 4 is a sectional view of the release device according to the first embodiment of the present invention.

FIG. 5 is a sectional view of a release device according to a second embodiment of the present invention.

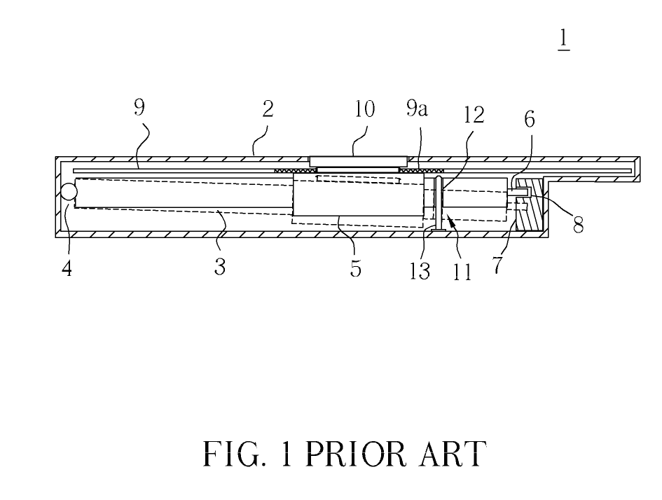

### DETAILED DESCRIPTION

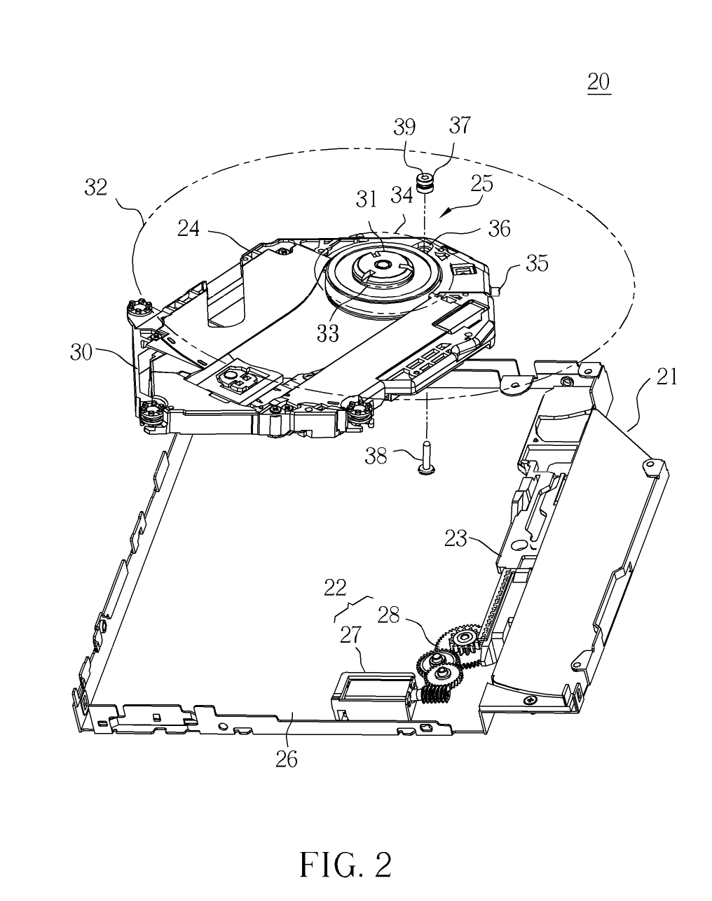

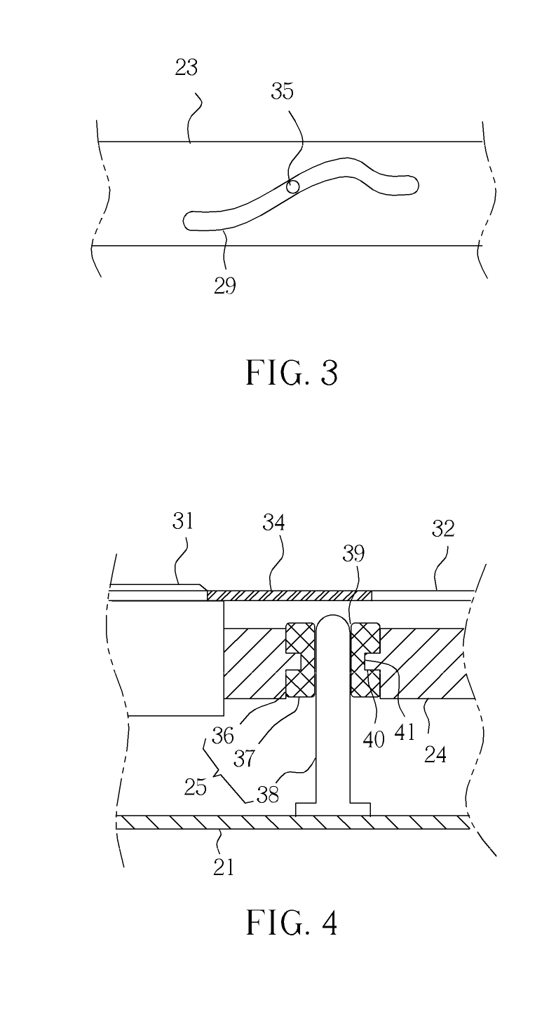

Please refer to FIG. 2. FIG. 2 is a diagram of a slot-in disk drive 20 with a release device 25 according to a first embodiment of the present invention. The slot-in disk drive 20 includes a casing 21, a drive device 22 installed inside the casing 21, a sliding component 23 installed on a lateral side of the casing 21, a traverse 24, and a release device 25. A hollow space is formed on the casing 21 and an opening 26 is formed on a front end of the casing 21. The drive device 22 includes a drive motor 27 and a set of gears 28 driven by the drive motor 27. The sliding component 23 is driven by the set of gears 28 so as to slide along the lateral side of the casing 21. Please refer to FIG. 3. FIG. 3 is a lateral view of the sliding component 23 of the present invention. A slot 29 is formed on a lateral surface of the sliding component 23.

Please refer to FIG. 2. A lateral side of the traverse 24 is pivoted to the casing 21 where is close to the opening 26 so as to form a pivoted portion 30. The traverse 24 can be rotated at a predetermined angle relative to the pivoted portion 30. A spindle motor 31 is installed on the traverse 24 for rotating an optical disk 32. A central hole 33 of the optical disk 32 is wedged on the spindle motor 31, and a non-data area 34 is designed on a predetermined area around the central hole 33. The release device 25 is installed on the traverse 24 adjacent to the spindle motor 31 and located in a position corresponding to the non-data area 34. As shown in FIG. 3, a sliding pin 35 protrudes from the other lateral side of the traverse 24 opposite to the pivoted portion 30 for inserting into the slot 29 of the sliding component 23.

The release device 25 includes a first hole 36, a buffer 37, and a release bar 38. The first hole 36 is formed on the traverse 24 adjacent to the spindle motor 31 and located in a position corresponding to the non-data area 34. The buffer 37 is a circular sheath installed inside the first hole 36. A second hole 39 is formed on the center of the buffer 37. The release bar 38 protrudes from a bottom of the casing 21 corresponding to the first hole 36. The release bar 38 as a stick can be inserted into the first hole 36. Please refer to FIG. 4. FIG. 4 is a sectional view of the release device 25 according to the first embodiment of the present invention. A circular slot 40 is formed on an outer surface of the buffer 37, and a circular protrusion 41 is formed in the first hole 36 for engaging with the circular slot 40 so as to fix the buffer 37 inside the first hole 36 of the traverse 24. The method of fixing the buffer 37 inside the first hole 36 is not limited to this embodiment and can be further fixed by ways of binding or clamping. The release bar 38 protruding from the bottom of the casing 21 can insert into the second hole 39 of the buffer 37. Because rotating angles of the traverse 24 is small enough and the buffer 37 is elastic, so that the release bar 38 can slide inside the second hole 39.

Please refer to FIG. 2, FIG. 3, and FIG. 4. When the optical disk 32 is loaded by the slot-in disk drive 20, the drive device 22 starts to drive the drive motor 27 for rotating the set of gears 28 so as to move the sliding component 23. The sliding pin 35 is ascended along to the slot 29 so that the traverse 24 is rotated upwardly relative to the pivoted portion 30. The spindle motor 31 of the traverse 24 is ascended for inserting into the optical disk 32 and then rotating the optical disk 32. The release bar 38 does not protrude out of the first hole 36 so that the release bar 38 separates from the rotating optical disk 32 at this time. The buffer 37 is installed between the release bar 38 and the traverse 24 so as to absorb vibration caused by the rotating optical disk 32 and to absorb the vibration transmitted between the release bar 38 and the casing 21. The buffer 37 can also absorbs vibration caused by external surroundings so as to decrease the vibration transmitted between the release bar 38 and the traverse 24 for raising the efficiency of reading/writing data. At the same time, the buffer 37 can prevent the release bar 38 and the traverse 24 from hitting to each other directly so as to decrease the vibration and noise.

When the optical disk 32 is ejected by the slot-in disk drive 20, the drive device 22 moves the sliding component 23, then the sliding pin 35 is descended along the slot 29 of the sliding component 23 so that the traverse 24 is rotated downwardly for driving the spindle motor 31 and the first hole 36 to descend. Thus, the buffer 37 installed inside the first hole 36 slides downwardly along the release bar 38, so that the release bar 38 can protrudes out of the first hole 36 to hold the non-data area 34 of the optical disk 32. The optical disk 32 can not be descended with the spindle motor 31 and departs from the spindle motor 31. Therefore, the optical disk 32 can be ejected.

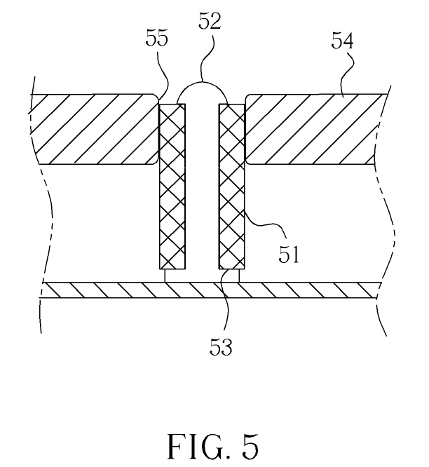

The release device 25 of the present invention utilizes the buffer 37 installed between the release bar 38 and the traverse 24 so as to isolate the vibration. The release device 25 according to the first embodiment of the present invention installs the buffer 37 on the traverse 24. Please refer to FIG. 5. FIG. 5 is a sectional view of a release device 50 according to a second embodiment of the present invention. The release device 50 includes a buffer 51 around a release bar 52 for isolating the vibration. A fixing slot 53 is formed on the release bar 52 whereon the buffer 51 can be installed, so that the buffer 51 can be fixed around the release bar 52. A first hole 55 is formed on a traverse 54 whereinto the release bar 52 with the buffer 51 can be inserted. That is, the buffer 51 can be a tube-shaped structure, and an inner surface of the first hole 55 and the buffer 51 can be parallel so that the release bar 52 with the buffer 51 is capable of inserting into the first hole 55 smoothly. When the traverse 54 is rotated, the buffer 51 can slide along the first hole 55 for preventing the traverse 54 from hitting the release bar 52 so as to isolate the vibration. Therefore, the buffer 51 can be fixed around the release bar 52, without moving with the traverse 54, for preventing the buffer 51 from falling.

In conclusion, the slot-in disk drive of the present invention installs the buffer between the traverse and the release bar for isolating the vibration transmitted between the traverse and the casing and for improving efficiency of reading/writing. At the same time, the slot-in disk drive of the present invention can be used for preventing the traverse and the release bar from hitting to each other directly and for decreasing the vibration and the noise. In addition, the slot-in disk drive of the present invention further can install the buffer around the release bar, without moving with the traverse, for preventing the buffer from falling.

Those skilled in the art will readily observe that numerous modifications and alterations of the device and method may be made while retaining the teachings of the invention.

What is claimed is:

1. A slot-in disk drive comprising:
a casing comprising a bottom, wherein a hollow space is formed inside the casing;
a traverse installed inside the casing, a side of the traverse being pivoted to the casing, and the traverse comprising:
a spindle motor for rotating an optical disk having a non-data area; and
a release device installed inside the casing, the release device comprising:
a first hole formed on the traverse adjacent to the spindle motor and located in a position corresponding to the non-data area;
a release bar protruding from the bottom of the casing in a position corresponding to the first hole for inserting into the first hole; and
a buffer installed between the release bar and the traverse for isolating vibration caused by the traverse.

2. The slot-in disk drive of claim 1, wherein the buffer is a circular sheath.

3. The slot-in disk drive of claim 1, wherein the buffer is fixed inside the first hole, and a second hole is formed on the buffer wherethrough the release bar passes.

4. The slot-in disk drive of claim 2, wherein a circular slot is formed on an outer surface of the buffer, and a circular protrusion is formed on the first hole for engaging with the circular slot.

5. The slot-in disk drive of claim 1, wherein the release bar separates from the optical disk when the optical disk is loaded by the slot-in disk drive, and the release bar touches the non-data area of the optical disk when the optical disk is withdrawn by the slot-in disk drive.

6. The slot-in disk drive of claim 5, wherein the release bar is disposed inside the first hole when the optical disk is loaded by the slot-in disk drive.

7. The slot-in disk drive of claim 1, wherein the buffer is disposed around the release bar.

8. The slot-in disk drive of claim 7, wherein a fixing slot is formed on a surface of the release bar for engaging with the buffer.

9. The slot-in disk drive of claim 8, wherein the buffer is a tube-shaped structure, and an inner surface of the first hole and the buffer are parallel so that the release bar with the buffer is capable of inserting into the first hole.
